(19) United States
(12) Patent Application Publication
(10) Pub. No.: US 2021/0073973 A1
(43) Pub. Date: Mar. 11, 2021

(54) METHOD AND APPARATUS FOR COMPONENT FAULT DETECTION BASED ON IMAGE

(71) Applicant: BEIJING BAIDU NETCOM SCIENCE TECHNOLOGY CO., LTD., Beijing (CN)

(72) Inventors: Jianfa ZOU, Beijing (CN); Ye SU, Beijing (CN); Minghao LIU, Beijing (CN); Lei NIE, Beijing (CN); Jiabing LENG, Beijing (CN); Yawei WEN, Beijing (CN); Tehui HUANG, Beijing (CN); Yulin XU, Beijing (CN); Jiangliang GUO, Beijing (CN); Xu LI, Beijing (CN)

(21) Appl. No.: 16/871,633

(22) Filed: May 11, 2020

(30) Foreign Application Priority Data
Sep. 6, 2019 (CN) 201910840743.2

(51) Int. Cl. G06T 7/00; G06T 7/80

(52) U.S. Cl. CPC G06T 7/0004; G06T 2207/20081; G06T 2207/30164; G06T 7/80

(57) ABSTRACT

Provided are a method and an apparatus for component fault detection based on an image, and a specific implementation is: when it is determined that an image shot by an image pickup apparatus for a component to be tested with a first shooting parameter does not meet a preset condition, adjusting the first shooting parameter to a second shooting parameter; controlling the image pickup apparatus to shoot for the component to be tested with the second shooting parameter to obtain a first image that meets the preset condition; and performing fault detection on the component to be tested according to the first image. The image pickup apparatus can be adjusted in real time, so that the image can be used for fault detection only when meeting the preset condition, thereby the image is kept stable, and the accuracy rate of component fault identification based on an image is improved.

### CROSS-REFERENCE TO RELATED APPLICATION

This application claims priority to Chinese Patent Application No. 201910840743.2, filed on Sep. 6, 2019, which is hereby incorporated by reference in its entirety.

### TECHNICAL FIELD

The present application relates to the field of component fault detection and, in particular, relates to a method and an apparatus for component fault detection based on an image.

### BACKGROUND

At present, with the development of science and technology, component manufacturers can use more intelligent automated production lines to achieve mass production of components in industrial production. For the components that have been manufactured on the production lines, the component manufacturers need to perform fault detection, remove the faulty components from the production lines in time or rework them, and perform subsequent packaging, leaving the factory, and other processes for the non-faulty components.

Component manufacturers mostly employ quality inspection workers, who are on duty at the production lines at any time, and judge whether the components are faulty by observing the components manufactured on the production lines with human eyes, which is more subjected to artificial restrictions. In some technologies, the component manufacturers also set up image pickup apparatuses on the production lines to take photos of the components manufactured on the production lines, and then the image identification is performed by machines to judge whether the components are faulty.

However, although automated detection for component faults can be achieved to a certain extent in the prior art, the environment in which the components on the production lines are located as well as the distance and angle between the components and the image pickup apparatuses when the components are transferred from the production lines are constantly changing, and thus the components themselves are different in the photos obtained by the image pickup apparatuses taking photos of the components under different conditions. When these photos are used for fault detection, the machines cannot accurately identify the faults of the components, resulting in a relatively low accuracy rate of the fault detection of the components.

### SUMMARY

A first aspect of the present application provides a method for component fault detection based on an image, including: when it is determined that an image shot by an image pickup apparatus for a component to be tested with a first shooting parameter does not meet a preset condition, adjusting the first shooting parameter to a second shooting parameter, where the first shooting parameter and the second shooting parameter both include multiple shooting angles; controlling the image pickup apparatus to shoot for the component to be tested with the second shooting parameter to obtain a first image that meets the preset condition, where the first image includes multiple images shot at multiple shooting angles; and performing fault detection on the component to be tested according to the first image.

Specifically, in the method provided in the first aspect, the image pickup apparatus can be adjusted in real time, so that the image shot for the component to be tested can be used for fault detection only when it meets the preset condition, thereby the image is kept stable, and the accuracy rate of component fault identification based on an image is improved.

In an embodiment of the first aspect of the present application, each of the first shooting parameter and the second shooting parameter further includes at least one of the following parameters: a distance between the image pickup apparatus and the component to be tested, a brightness of the image pickup apparatus, a color of the image pickup apparatus, and a focal length of the image pickup apparatus, where the first shooting parameter and the second shooting parameter is different in at least one of the parameters.

Specifically, in the embodiment of the first aspect described above, when the image pickup apparatus shoots for the component to be tested, parameters such as the distance between the image pickup apparatus and the component to be tested, the brightness of the image pickup apparatus, the color of the image pickup apparatus, and the focal length of the image pickup apparatus can be adjusted, and then the adjusted parameters are used to shoot for the component to be tested. From the perspective of the image pickup apparatus, the image shot by the image pickup apparatus is relatively stable, so as to achieve the technical effect of improving the accuracy rate of component fault identification.

In an embodiment of the first aspect of the present application, the preset condition includes one or more of the following: that a coverage area of the component to be tested in the image meets a preset size, that a surface position presented by the component to be tested in the image meets a preset surface position, that the image meets a preset brightness, that the image meets a preset color value, and that the image meets a preset sharpness.

Specifically, in the embodiment of the first aspect described above, the shooting is performed for the component to be tested at least after the image shot by the image pickup apparatus meets the condition. Thereby before the image pickup apparatus shoots for the component to be tested, the judging is performed using the preset conditions in the embodiment and the shooting parameters of the image pickup apparatus are adjusted, so that the image shot by the image pickup apparatus meets the above preset condition, so as to achieve the technical effect of improving the accuracy rate of component fault identification.

In an embodiment of the first aspect of the present application, the multiple shooting angles are used to shoot for the component to be tested from six sides: top, bottom, left, right, front and back sides, and the shooting is performed from three directions for each side.

Specifically, in the embodiment of the first aspect described above, the image pickup apparatus shoots for the component to be tested from six sides: top, bottom, left, right, front and back sides, and the shooting is performed from three directions for each side. The total of 18 images are obtained and used for the fault detection of the component, thereby the fault detection is performed on the component to be tested more comprehensively, and the situation that the component is undetected at one angle or one side of the component is undetected caused by blocking and other reasons is reduced, which further improves the accuracy rate of component fault detection.

In an embodiment of the first aspect of the present application, the performing fault detection on the component to be tested according to the first image includes: inputting the first image into a machine learning model to obtain a fault detection result of the component to be tested; where the machine learning model is obtained by images of multiple historical components, and an image of each historical component includes multiple images shot at different shooting angles.

Specifically, in the embodiment of the first aspect described above, an electronic device as the executive entity specifically performs fault detection on the first image of the component to be tested through the machine learning model, which can achieve faster image processing efficiency and certain accuracy.

In an embodiment of the first aspect of the present application, the method further includes: controlling the image pickup apparatus to shoot for the multiple historical components to obtain images of the multiple historical components that meet the preset condition; and training the images of the multiple historical components through a machine learning algorithm to obtain the machine learning model; where the machine learning model includes an image feature of a faulty component in the multiple historical components, and an image feature of a normal component in the multiple historical components.

Specifically, in the embodiment of the first aspect described above, when training the machine learning model for component fault detection, the electronic device as the executive entity only needs to shoot images of historical components that meet the preset condition and send the images into the machine learning model, and then image feature extraction and automatic labeling is performed by the machine learning model, thereby the image features of faulty components and the image features of non-faulty components are obtained by classification. Thus, the detection personnel does not need to label the faulty components, or select the faulty components manually for shooting, which further reduces the degree of manual participation in the entire process of component fault detection, improves the efficiency and the degree of intelligence of component fault detection.

In an embodiment of the first aspect of the present application, the fault detection result of the component to be tested includes: that the component to be tested is normal, that the component to be tested has a fault with which the machine learning model has been trained, and that the component to be tested has a fault with which the machine learning model is not trained.

When the detection result of the component to be tested is that the component to be tested has a fault with which the machine learning model is not trained, the first image is inputted into the machine learning model for training, to update the machine learning model.

Specifically, in the embodiment of the first aspect described above, the machine learning model can be updated after detecting that the component has a new fault. Thereby after this kind of fault occurs again in subsequent components, the detection and identification can be performed by the machine learning model directly, thus ensuring the update of the model and improving the efficiency of component fault detection.

In an embodiment of the first aspect of the present application, after performing fault detection on the component to be tested according to the first image, the method further includes: sending indication information to a server when it is determined that the component to be tested is faulty.

Specifically, in the embodiment of the first aspect described above, only after it is determined that the component to be tested is faulty, the electronic device sends the indication information to the server to indicate that the component to be tested is faulty, which reduces frequent interaction between the electronic device and the server. And the executive entity of the fault detection of the component to be tested is disposed at the front end of a production line, which reduces the time that the image pickup apparatus transfers the image to the server, and improves the real-time performance of fault detection.

A second aspect of the present application provides an apparatus for component fault detection based on an image that can be used to execute the method for component fault detection based on an image provided in the first aspect of the present application, where the apparatus includes: an adjusting module, a shooting module, and a detection module. Specifically, the adjusting module is configured to: when it is determined that an image shot by an image pickup for a component to be tested with a first shooting parameter does not meet a preset condition, adjust the first shooting parameter to a second shooting parameter, where the first shooting parameter and the second shooting parameter both include multiple shooting angles; the shooting module is configured to control the image pickup apparatus to shoot for the component to be tested with the second shooting parameter to obtain a first image that meets the preset condition, where the first image includes multiple images shot at multiple shooting angles; and the detection module is configured to perform fault detection on the component to be tested according to the first image.

In an embodiment of the second aspect of the present application, the shooting parameter further includes at least one of the following parameters: a distance between the image pickup apparatus and the component to be tested, a brightness of the image pickup apparatus, a color of the image pickup apparatus, and a focal length of the image pickup apparatus, where the first shooting parameter and the second shooting parameter is different in at least one of the parameters.

In an embodiment of the second aspect of the present application, the preset condition includes one or more of the following: that a coverage area of the component to be tested in the image meets a preset size, that a surface position presented by the component to be tested in the image meets a preset surface position, that the image meets a preset brightness, that the image meets a preset color value, and that the image meets a preset sharpness.

In an embodiment of the second aspect of the present application, the multiple shooting angles are used to shoot for the component to be tested from six sides: top, bottom, left, right, front and back sides, and the shooting is performed from three directions for each side.

In an embodiment of the second aspect of the present application, the detection module is specifically configured to input the first image into a machine learning model to obtain a fault detection result of the component to be tested; where the machine learning model is obtained by images of multiple historical components, and an image of each historical component includes multiple images shot at different shooting angles.

In an embodiment of the second aspect of the present application, the shooting module is further configured to control the image pickup apparatus to shoot for multiple historical components to obtain images of the multiple historical components that meet the preset condition; and the detection module is further configured to train the images of the multiple historical components through a machine learning algorithm to obtain the machine learning model; where the machine learning model includes an image feature of a faulty component in the multiple historical components, and an image feature of a normal component in the multiple historical components.

In an embodiment of the second aspect of the present application, the fault detection result of the component to be tested includes: that the component to be tested is normal, that the component to be tested has a fault with which the machine learning model has been trained, and that the component to be tested has a fault with which the machine learning model is not trained.

In an embodiment of the second aspect of the present application, the detection module is further configured to: when the detection result of the component to be tested is that the component to be tested has a fault with which the machine learning model is not trained, input the first image into the machine learning model for training, to update the machine learning model.

In an embodiment of the second aspect of the present application, the apparatus further includes: a sending module. The sending module is configured to: when it is determined that the component to be tested is faulty, send indication information to a server.

A third aspect of the present application provides an electronic device, including: at least one processor; and a memory communicatively connected to the at least one processor; where the memory stores instructions which are executable by the at least one processor, and the instruction are executed by the at least one processor, so that the at least one processor is capable of executing the method according to any one of the first aspect of the present application.

A fourth aspect of the present application provides a non-transitory computer-readable storage medium, having computer instructions stored thereon, which are used to enable a computer to execute the method according to any one of the first aspect of the present application.

In summary, in the method and the apparatus for component fault detection based on an image provided in the present application, when it is determined that the image of the component to be tested shot by the image pickup apparatus does not meet the preset condition, the shooting parameter of the image pick apparatus needs to be adjusted to the second shooting parameter from the first shooting parameter, the image pickup apparatus is then controlled to shoot the first image of the component to be tested with the adjusted second shooting parameter, and finally the fault detection is performed through the first image.

Therefore, in the present application, when acquiring the image for fault detection, the parameter of the image pickup apparatus needs to be adjusted, so that the image shot by the image pickup apparatus meets the preset condition and then is used for fault detection, ensuring that the component to be detected in the image shot by the image pickup apparatus is relatively stable. Thus, the technical problem of the unstable state of the component to be tested in the image shot by the image pickup apparatus caused by the wrong parameters of the image pick apparatus and the change in the relative position between the component to be tested and the image pickup apparatus is overcome. The component fault in the image can be identified by the machine learning model more directly, which avoids that the change in the state of the component to be tested is mistaken as a fault by the machine learning model when performing fault detection based on the image, thereby achieving the technical effect of improving the accuracy rate of component fault detection.

Other effects of the above optional manners will be described below in combination with specific embodiments.

### BRIEF DESCRIPTION OF THE DRAWINGS

The drawings are used to better understand the solutions, and do not constitute a limitation to the present application. Among them:

FIG. 1 is a method for component fault detection in the prior art;

FIG. 2 is another method for component fault detection in the prior art;

FIG. 3 is a schematic diagram of an image shot by an image pickup apparatus in the prior art;

FIG. 4 is a schematic diagram according to a first embodiment of the present application;

FIG. 5 is a schematic diagram of sides of a component to be tested in the present application;

FIG. 6 is a schematic diagram of shooting angles when shooting for a component to be tested in the present application;

FIG. 7 is a schematic diagram of shooting an image of a component to be tested by an image pickup apparatus in the present application;

FIG. 8 is a schematic diagram according to a second embodiment of the present application;

FIG. 9 is a schematic structural diagram of a first embodiment of an apparatus for component fault detection based on an image provided by the present application;

FIG. 10 is a schematic structural diagram of a second embodiment of an apparatus for component fault detection based on an image provided by the present application; and

FIG. 11 is a schematic structural diagram of an electronic device for realizing a method for component fault detection based on an image according to an embodiment of the present application.

### DETAILED DESCRIPTION OF THE EMBODIMENTS

Exemplary embodiments of the present application are described below with reference to the accompanying drawings, which include various details of the embodiments of the present application to facilitate understanding, and should be considered as merely exemplary. Therefore, those skilled in the art should recognize that various changes and modifications can be made to the embodiments described herein without departing from the scope and spirit of the application. Similarly, for clarity and conciseness, descriptions of well-known functions and structures are omitted in the following description.

Before formally introducing the embodiments of the present application, the application scenarios of the present application and the problems in the prior art will be described with reference to the drawings.

Specifically, the present application is applied to the process of component fault detection after a component manufacturer manufactures a component on a production line in industrial production. For example, for a manufacturer of mobile phone charging ports, the charging ports are mass produced through an intelligent automated production line, and components manufactured from the production line can be packaged or left from the factory. But in the process of manufacturing components on the production line, faulty components may be manufactured due to machine failure, production condition restrictions and other reasons, that is, the production line may have a certain defective rate. At this time, the component manufacturer needs to perform fault detection on the components, and remove the faulty components from the production line, so that the faulty components will not continue to leave the factory through subsequent production processes, and only the non-faulty components will continue to go through subsequent production processes like packaging, leaving the factory, etc., thereby reducing the defective rate of out-going products of the component manufacturer, and improving the corporate reputation of the component manufacturer.

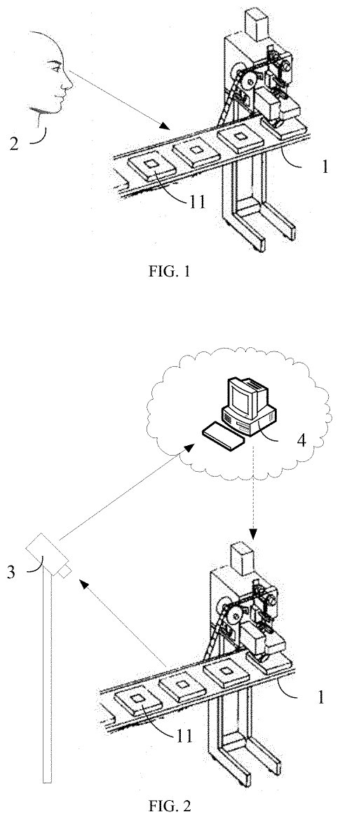

FIG. 1 is a method for component fault detection in the prior art. As shown in FIG. 1, some component manufacturers may hire a quality inspection worker 2 in order to reduce the defective rate of out-going components. Once the production line 1 starts to manufacture components, the quality inspection worker 2 is on duty by the production line 1 at any time, and judges whether a component 11 is faulty by observing the component 11 manufactured on the production line 1 with human eyes. However, this traditional method is a labor-intensive activity, which is greatly affected by the factor of labor shortage; and there are subjective differences in the judgment standards of different quality inspection workers, resulting in problems of low accuracy rate and low efficiency of fault detection.

FIG. 2 is another method for component fault detection in the prior art, FIG. 2 shows an automated fault detection method used by another component manufacturers, where the component manufacturers will set an image pickup apparatus 3 on the production line 1. After the image pickup apparatus 3 shoots a photo for the component 11 produced on the production line 1, the photo is sent to a background server 4, and the background server 4 detects whether the component is faulty by means of image identification. If the background server 4 detects that the component 11 is faulty, the parameters of the production line 1 can also be adjusted in time to prevent subsequent components from having the same fault.

However, in the prior art as shown in FIG. 2, some background servers also use the manner of machine learning when processing the images of components, although automated fault detection of components is realized to a certain extent, a machine learning model needs to be trained using the pictures of historical faulty components, and then be used to perform fault identification processing on a picture of a component to be detected in real time. At this time, the machine learning model determines whether the component to be detected is faulty by way of judging the similarity between the picture of the component to be detected and the historical faulty pictures. This requires that the non-faulty area in the picture of the component to be detected needs to remain stable relative to the non-faulty area in the pictures of the historical faulty components. Otherwise, once the angle of the component to be detected has a slight difference in the picture collected by the image pickup apparatus, or the lack of brightness in the picture results in the component to be detected being blurred, such change will result in that the component to be detected in the picture is detected as a faulty component by the machine learning model due to an algorithm, even if the component is not faulty.

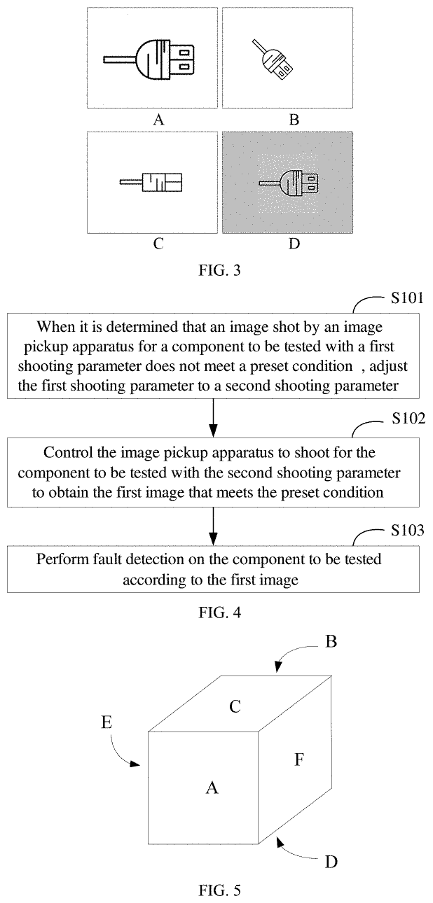

At the same time, since the components outputted on the production line will not at the same angle and the same state, and may be scattered on a conveyor belt, the environment where the components on the production line are located as well as the distance and angle between the components and the image pickup apparatus when the components are transferred from the production line are changing at any time; the components themselves are different in the photos shot by the image pickup apparatus for the components under different conditions, resulting in that when the image pickup apparatus shoots for each component, the component in each photo may have different states. For example, FIG. 3 is a schematic diagram of an image shot by an image pickup apparatus in the prior art. In the example shown in FIG. 3, when the production line directly outputs components without arranging them, a front side of the component (figure A), the front side of the component at a certain angle (figure B), a side surface of the component (figure C), and the image of the component that is more blurred due to insufficient ambient light (figure D) may be shot by the image pickup apparatus. At this time, when the fault detection is further performed on the obtained image by the machine learning model, due to the component images themselves having various differences, the machine learning model cannot accurately identify the true faulty of the components when comparing the component images, and may detect a non-faulty part of the image as a faulty part, resulting in a lower accuracy rate of component fault detection.

Therefore, based on the above technical problems in the prior art, the present application proposes a method for component fault detection based on an image. When it is determined that an image of a component to be tested shot by an image pickup apparatus does not meet a preset condition, a shooting parameter of the image pickup apparatus is adjusted, and the image pickup apparatus is controlled to use the adjusted shooting parameter to shoot an image of the component to be tested. Then fault detection is performed through the obtained image to ensure the relative stability of the component to be detected in the image, so that the machine learning model more accurately detects the faulty part of the component to be tested in the image, thereby improving the accuracy rate of the component fault detection.

The following embodiments of the present application will be illustrated with reference to the drawings.

FIG. 4 is a schematic diagram according to a first embodiment of the present application. FIG. 4 shows a schematic flowchart of a method for component fault detection based on an image provided in the present application, where the method may be executed by any electronic device having related data processing functions, for example, a mobile phone, a tablet, a laptop, a desktop computer, or a server, etc. Preferably, the electronic device may be the image pickup apparatus 3 or the server 4 in the scene shown in FIG. 2. Or, the method may also be executed by a chip self-adhesive in the electronic device, for example, a CPU or a GPU. In the embodiments of the present application, the electronic device executing the method shown in FIG. 4 is taken as an example for illustration, but the embodiments are not limited thereto. Specifically, the method includes:

S101: when it is determined that an image shot by an image pickup apparatus for a component to be tested with a first shooting parameter does not meet a preset condition, adjust the first shooting parameter to a second shooting parameter, where the first shooting parameter and the second shooting parameters both include multiple shooting angles.

Specifically, when the image pickup apparatus shoots an image of a component to be detected, the electronic device, which is the executive entity of the present application, needs to adjust the shooting parameter of the image pickup apparatus if it is judged that the shot image does not meet a preset requirement. The parameter used when the image pickup apparatus shoots for the component to be tested before the adjustment is denoted as the first shooting parameter. When it is determined that the image shot by the image pickup apparatus with the first shooting parameter does not meet the preset condition, the shooting parameter needs to be adjusted, and the adjusted parameter is denoted as the second shooting parameter. The image shot by the image pickup apparatus with the second shooting parameter meets the preset condition.

The following illustrates multiple shooting angles in the first shooting parameter and the second shooting parameter in this embodiment with reference to the accompanying drawings. Exemplarily, FIG. 5 is a schematic diagram of sides of a component to be tested in the present application. The component to be tested may be a component that can be abstractly illustrated by a cuboid, such as a mobile phone charging port. The component is divided based on six sides in FIG. 5, where the six sides: front, back, top, bottom, left and right sides of the component to be tested are denoted as A, B, C, D, E, and F sides in turn.

In a specific implementation, FIG. 6 is a schematic diagram of shooting angles when shooting for a component to be tested in the present application. Referring to FIG. 6, if all the components manufactured on the production line are outputted through a conveyor belt in the way of D-side down and C-side up, the image pickup apparatus can shoot for the upward C-side of the component to be tested through three angles of T2, T1 and T3 and obtain three images of the component to be tested. T2 may be perpendicular to the C-side of the component, T1 may be at a 45-degree angle to T2, and T3 may be at a 45-degree angle to T2. In the example shown in FIG. 6, the image pickup apparatus for shooting for the component to be tested may include only one camera, and then by moving the position of the image pickup apparatus, the image pickup apparatus can shoot for the component to be tested at different angles T1, T2, and T3 as shown in the figure to obtain multiple images of the component to be tested, which are denoted as a first image. Or, the image pickup apparatus may also include multiple cameras, for example, three cameras shoot for the components to be tested at T1, T2, and T3 in FIG. 6, respectively, to obtain multiple images of the component to be tested, which are denoted as the first image.

Further, in order to perform fault detection on the component to be tested more comprehensively, the multiple shooting angles described in this embodiment are used to shoot for the component to be tested from six sides: top, bottom, left, right, front and back sides, and the shooting is performed from three directions for each side. For example, in combination with the component to be tested shown in FIG. 5, when performing fault detection on the component to be tested, the image pickup apparatus will shoot for the component to be tested in three directions of T1, T2, and T3 as shown in FIG. 6 for each of the six sides of the component to be tested, i.e., A-side, B-side, C-side, D-side, E-side, and F-side, so that 6*3=18 images of the component to be tested are obtained.

When the image pickup apparatus shoots the above multiple images of the component to be tested, it is necessary to determine whether the image shot with the first shooting parameter meets the preset condition, if not, the first shooting parameter needs to be adjusted to the second shooting parameter, to shoot an image meeting the preset condition. For each shooting angle of each side of the component to be tested, the shooting parameter and the preset condition may be different. For example, the shooting parameter also includes at least one of the following parameters: a distance between the image pickup apparatus and the component to be tested, a brightness of the image pickup apparatus, a color of the image pickup apparatus, and a focal length of the image pickup apparatus; the preset condition includes one or more of the following: that a coverage range of the component to be tested in the image meets a preset size, that a surface position presented by the component to be tested in the image meets a preset surface position, that the image meets a preset brightness, that the image meets a preset color value, and that the image meets a preset sharpness.

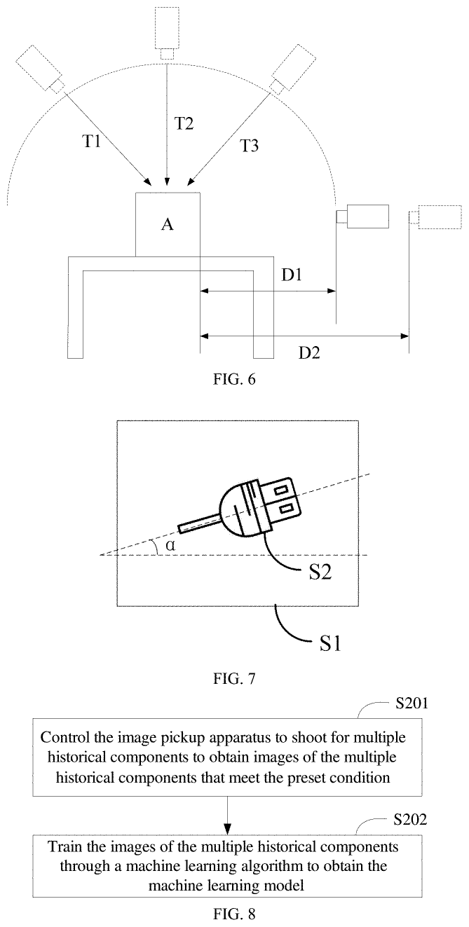

The following illustrates the shooting parameter and the preset condition by taking one shooting angle of one side as an example. Exemplarily, FIG. 7 is a schematic diagram of shooting an image of a component to be tested by an image pickup apparatus in the present application, and FIG. 7 shows the preset condition which needs to be met when the image pickup apparatus shoots for the C-side of the component to be tested at angle T2 as shown in FIG. 6. The preset condition may be the coverage area of the component to be tested in the entire image, for example, in FIG. 7, if the area of the image shot by the image pickup apparatus is S1, then the area of the coverage area of the component to be tested in the image is S2; or, the preset condition may be the surface position presented by the component to be tested in the image, for example, the component to be tested in FIG. 7 needs to present the upper surface instead of the side surface; or, the preset condition may also be that there is a preset angle a between the central axis of the component and the horizontal direction as shown in FIG. 7; or, the preset condition may also be the brightness value, color value, and sharpness of the image itself.

When the components produced on the production line are outputted through the conveyor belt, once the components are scattered on the conveyor belt, the state as shown in FIG. 6 will not be completely maintained for the image pickup apparatus to directly shoot for the component to be tested. Therefore, when the image pickup apparatus shoots for the C-side of the component to be tested at angle T2 as shown in FIG. 6, it is necessary to determine whether the image shot with the current first shooting parameter can meet the preset condition according to the current first shooting parameter of the image pickup apparatus and the real-time state of the component to be tested, and if not, the first shooting parameter needs to be adjusted to the second shooting parameter to shoot an image of the component to be tested that meets the preset condition as shown in FIG. 7.

For example, in the example shown in FIG. 6, the component to be tested outputted from the production line is on the conveyor belt and far from the image pickup apparatus, thus, if the image pickup apparatus shoots the image of the component to be tested at a distance D2 and the area covered by the component is smaller than S2 shown in FIG. 7, then the distance between the image pickup apparatus and the component to be tested can be adjusted, so that in the image shot by the image pickup apparatus for the component to be tested with the adjusted distance D1, the area covered by the component is equal to S2 as shown in FIG. 7. For another example, the angle of the component to be tested outputted from the production line is different on the conveyor belt, thus, when the angle between the central axis of the component and the horizontal direction is smaller than a shown in FIG. 7 in the image shot by the image pickup apparatus for the component to be tested at this time, a rotation operation can be performed on the image pickup apparatus, so that the angle between the central axis of the component and the horizontal direction is equal to a as shown in FIG. 7 in the image shot by the image pickup apparatus for the component to be detected at the rotated angle. For another example, when the current ambient light is insufficient, resulting in that the brightness of the image shot by the image pickup apparatus is insufficient, the image pickup apparatus can be adjusted by increasing the exposure of the image pickup apparatus or turning on the flash, so that the image shot by the image pickup apparatus after the adjustment meets the preset brightness requirement as shown in FIG. 7. For another example, when the focusing of image pickup apparatus is inaccurate, resulting in that the image shot by the image pickup apparatus is not clear, the focal length of the image pickup apparatus can be adjusted to achieve focusing, so that the sharpness of the image shot by the image pickup apparatus for the component to be tested with the adjusted focal length meets the preset sharpness as shown in FIG. 7. For another example, when the color of the image shot by image pickup apparatus is inaccurate at this time due to the problem such as inaccurate color value of the image pickup apparatus, the color value of the image pickup apparatus can be adjusted to achieve focusing, so that the color value of the image shot by the image pickup apparatus for the component to be tested with the adjusted focal length meets the preset color value as shown in FIG. 7.

It can be understood that in the present application, from the perspective of adjusting the image pickup apparatus, the shooting parameter of the image pickup apparatus is adjusted, so that the image of the component to be detected shot by the image pickup apparatus meets the preset condition. In other possible implementations, when it is determined that the image shot by the image pickup apparatus does not meet the preset condition, the angle and distance and others of the component to be tested on the production line can also be adjusted, so that the image pickup apparatus can shoot the image of the component to be tested that meets the preset condition without adjusting the shooting parameter.

S102: Control the image pickup apparatus to shoot for the component to be tested with the second shooting parameter to obtain the first image that meets the preset condition, where the first image includes multiple images shot at multiple shooting angles.

Specifically, according to the above example, in S102, the image pickup apparatus shoots for the component to be tested from 18 directions in total (involving six sides of the component to be tested and three directions for each side) with the adjusted second shooting parameter, and obtains 18 images of the component to be tested with each image meeting a respective preset condition, which are denoted as the first image.

Optionally, for the component to be detected outputted from the production line, the six sides of the component to be detected can be flipped upward in turn by way of flipping the component to be detected; for the image pickup apparatus, each time the component to be detected is flipped, the shooting can be performed for the component to be detected sequentially at three angles of T1, T2, and T3 as shown in FIG. 6, and the side and angle corresponding to each image are marked for subsequent detection.

S103: Perform fault detection on the component to be tested according to the first image.

In S103, the electronic device as the executive entity of this embodiment performs fault detection on the component to be tested based on the first image of the component to be tested obtained in S102.

In a specific implementation, the electronic device can send the first image to the machine learning model. The detection on the component to be tested in the image is performed by the machine learning model, and whether the component to be tested is faulty and the type of the fault are determined according to an output result of the machine learning model.

Optionally, the machine learning model includes, but is not limited to, for example: a convolutional neural network, a k-Nearest Neighbor algorithm (KNN), a Support Vector Machine (SVM) or other machine learning models based on deep learning, such as instance segmentation (Mask-RCNN).

The instance segmentation Mask RCNN algorithm is a two-stage framework. In the first stage, an image is scanned and proposals (that is, areas that may contain an object) are generated; in the second stage, proposals are classified and boundary boxes and masks are generated. Mask R-CNN is an extension of Faster R-CNN and was proposed by the same author last year. The Faster RCNN is a popular object detection framework, and the Mask RCNN extends it into an instance segmentation framework. The Mask RCNN is a new convolutional network based on the Faster RCNN architecture, and completes instance segmentation at one fell swoop; this method effectively detects objects, and meanwhile completes high-quality instance segmentation. The Mask RCNN algorithm is mainly to extend the original Faster-RCNN, and add a branch to use the existing detection to perform parallel prediction on the object. At the same time, this network structure is relatively easy to realize and train, and can be easily applied to other fields, such as object detection, segmentation, and key point detection of people.

Further, since the first image includes multiple images, for example, the 18 images in the above example, for the machine learning model, models corresponding one-to-one to the 18 images for detection are also set up. Therefore, the 18 images need to be inputted into the machine learning model one by one in a preset order, and detected by the corresponding model in the machine learning model to output a fault detection result. For example, in the detection result of a single image outputted by machine learning, “1” indicates that a fault is detected, and “0” indicates that no fault is detected. Then the electronic device determines that the component to be detected is not faulty only when judging that the detection results of all 18 images outputted by the machine learning model are “0”, and as long as one or more output results are “1”, it can be determined that the component to be detected is faulty.

In summary, in the method for component fault detection based on an image provided in this embodiment, when it is determined that the image of the component to be tested shot by the image pickup apparatus does not meet the preset condition, the shooting parameter of the image pickup apparatus needs to be adjusted to the second shooting parameter from the first shooting parameter; the image pickup apparatus is then controlled to shoot the first image of the component to be tested with the adjusted second shooting parameter; and finally, the fault detection is performed through the first image. Therefore, in the method for component fault detection based on an image provided in this embodiment, when acquiring an image for fault detection, parameters of the image pickup apparatus need to be adjusted so that the image shot by the image pickup apparatus meets the preset condition and can then be used for fault detection, which ensures the component to be detected in the image shot by the image pickup apparatus is relatively stable, thereby avoiding the unstable state of the component to be tested itself in the image shot by the image pickup apparatus caused by the wrong parameters of the image pick apparatus and the change in the relative position between the component to be tested and the image pickup apparatus. The component fault in the image can be identified by the machine learning model more directly, which avoids that the change in the state of the component to be tested is mistaken as a fault by the machine learning model when performing fault detection based on the image, thereby improving the accuracy rate of component fault detection.

In addition, in this embodiment, since the images shot by the image pickup apparatus meet the preset condition when they are sent into the machine learning model, the machine learning model can identify the images without performing pre-processing to the images such as scaling, and the calculation amount of the machine learning model is reduced to a certain extent. At the same time, the component images obtained by the image pickup apparatus in multiple angles in this embodiment make the fault detection more comprehensive, which further improves the accuracy rate of the component fault detection.

Further, on the basis of the above embodiment, the present application also provides a training method of the machine learning model that can be used when performing fault detection on the first image in S103. For example, FIG. 8 is a schematic diagram according to a second embodiment of the present application. The executive entity of the embodiment shown in FIG. 8 may be the electronic device in the above embodiment, and before performing fault detection on the component to be tested, the training of the machine learning model is first performed. Specifically, the method includes:

S201: control the image pickup apparatus to shoot for multiple historical components to obtain images of the multiple historical components that meet the preset condition.

Specifically, in S201, the electronic device controls the image pickup apparatus to shoot for multiple historical components in the same manner as in S101-S102 to obtain images of the multiple historical components. The image of each historical component includes multiple images shot at different shooting angles, and the historical components include faulty components and non-faulty components.

S202: Train the images of the multiple historical components through a machine learning algorithm to obtain the machine learning model; where the machine learning model includes image features of faulty components in the multiple historical components, and image features of normal components in the multiple historical components.

Specifically, in S202, the electronic device sends the multiple historical component images obtained in S201 into the machine learning model one by one. After the features of all historical component images are extracted by machine learning, the historical component images are distinguished, and the features of the historical images are divided into two categories: image features of faulty components and image features of non-faulty components. Optionally, the present application does not limit the machine learning model, and the machine learning model may be any deep learning model that can perform automatic feature labeling.

Subsequently, the machine learning model obtained through S202 can be used to perform fault detection on the component to be tested as in S103 in the embodiment shown in FIG. 4.

In summary, in the method for training the machine learning model provided in this embodiment, when training the machine learning model for component fault detection, the electronic device as the executive entity only needs to shoot images of historical components that meet the preset condition and then send the images into the machine learning model; the machine learning model performs image feature extraction and automatic labeling, thereby classifying the image features of faulty components and the image features of non-faulty components. Thereby the detection personnel does not need to label the faulty components, or select the faulty components manually for shooting, which further reduces the degree of manual participation in the entire process of component fault detection, and improves the efficiency of component fault detection.

Further, on the basis of the above embodiments of the present application, the fault detection result of the component to be tested includes: that the component to be tested is normal, that the component to be tested has a fault with which the machine learning model has been trained, and that the component to be tested has a fault with which the machine learning model is not trained.

The machine learning model can compare the similarity of the image feature of the component to be tested with the image features of the faulty components and the image features of the non-faulty components, and then output the results of the component to be tested being normal, the component to be tested being faulty; in addition, if the image feature of the component to be tested is not similar to the image features of the faulty components and the image features of the non-faulty components, the image feature of the component to be tested may be the case that the component to be tested has a fault with which the machine learning model is not trained.

After determining that a new image feature of component fault is found, the machine learning model can be updated, and the first image of the component to be tested can be inputted into the machine learning model for training, to update the machine learning model.

In summary, in the method for updating the machine learning model provided in this embodiment, the machine learning model can be updated after detecting that a component has a new fault. Thereby, after this kind of fault occurs again in subsequent components, the detection and identification can be performed by the machine learning model directly, thus ensuring the update of the model and improving the efficiency of component fault detection.

Further, on the basis of the above embodiments of the present application, after S103, the electronic device can also send indication information to a server after determining that the component to be tested is faulty.

Specifically, this embodiment may be applied to the production line shown in FIG. 2, and the electronic device may be set on the image pickup apparatus 3 shown in FIG. 2. Different from the prior art in which the electronic device performs fault detection on the component after a background server sends an instruction to the electronic device, in this embodiment, the electronic device controls the image pickup apparatus to shoot for the component to be tested in real time, and performs fault detection on the component to be tested according to the shot image; and only after it is determined that the component to be tested is faulty, the electronic device sends indication information to the server to indicate that the component to be tested is faulty, which reduces frequent interaction between the electronic device and the server. And the executive entity of the fault detection of the component to be tested is disposed at the front end of the production line, which reduces the time that the image pickup apparatus transfers the image to the server, and improves the real-time performance of fault detection.

In the above embodiments provided in the present application, the method provided in the embodiments of the present application is described from the perspective of an electronic device. In order to realize the functions in the method provided by the embodiments of the present application, the electronic device as the executive entity may further include a hardware structure and/or a software module, and the above functions are realized in the form of a hardware structure, a software module, or a hardware structure together with a software module. Whether one of the above functions is executed by a hardware structure, a software module, or a hardware structure together with a software module depends on the specific application of the technical solution and the design constraint conditions.

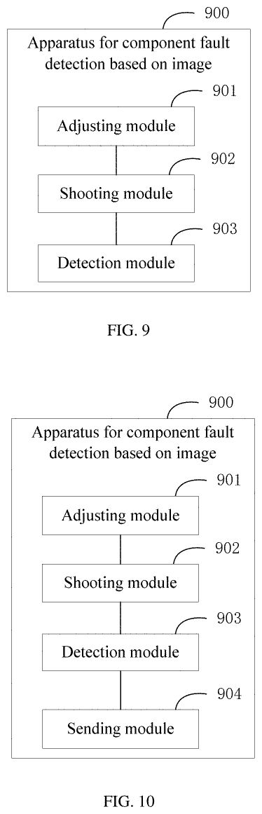

For example, FIG. 9 is a schematic structural diagram of a first embodiment of an apparatus for component fault detection based on an image provided in the present application. The apparatus 900 for component fault detection based on an image as shown in FIG. 9 includes: an adjusting module 901, a shooting module 902, and a detection module 903, where the adjusting module 901 is configured to: when it is determined that an image shot by an image pickup apparatus for a component to be tested with a first shooting parameter does not meet a preset condition, adjust the first shooting parameter to a second shooting parameter, where the first shooting parameter and the second shooting both include multiple shooting angles; the shooting module 902 is configured to control the image pickup apparatus to shoot for the component to be tested with the second shooting parameter to obtain a first image that meets the preset condition, where the first image includes images shot at multiple shooting angles; and the detection module 903 is configured to perform fault detection on the component to be tested according to the first image.

Optionally, the shooting parameter further include at least one of the following parameters: a distance between the image pickup apparatus and the component to be tested, a brightness of the image pickup apparatus, a color of the image pickup apparatus, and a focal length of the image pickup apparatus, where the first shooting parameter and the second shooting parameter is different in at least one of the parameters.

Optionally, the preset condition includes one or more of the following: that a coverage range of the component to be tested in the image meets a preset size, that a surface position presented by the component to be tested in the image meets a preset surface position, that the image meets a preset brightness, that the image meets a preset color value, and that the image meets a preset sharpness.

Optionally, the multiple shooting angles are used to shoot for the component to be tested from six sides: top, bottom, left, right, front and back sides, and the shooting is performed from three directions for each side.

Optionally, the detection module 903 is specifically configured to input the first image into a machine learning model to obtain a fault detection result of the component to be tested; where the machine learning model is obtained by images of multiple historical components, and an image of each historical component includes multiple images shot at different shooting angles.

Optionally, the shooting module 902 is further configured to control the image pickup apparatus to shoot for the multiple historical components to obtain images of the multiple historical components that meet the preset condition; the detection module 903 is further configured to train the images of the multiple historical components through a machine learning algorithm to obtain the machine learning model; where the machine learning model includes an image feature of a faulty component in the multiple historical components, and an image feature of a normal component in the multiple historical components.

Optionally, the fault detection result of the component to be tested includes:

that the component to be tested is normal, that the component to be tested has a fault with which the machine learning model has been trained, and that the component to be tested has a fault with which the machine learning model is not trained.

Optionally, the detection module 903 is further configured to: when the detection result of the component to be tested is that the component to be tested has a fault with which the machine learning model is not trained, input the first image into the machine learning model for training, to update the machine learning model.

FIG. 10 is a schematic structural diagram of a second embodiment of an apparatus for component fault detection based on an image provided in the present application. The apparatus shown in FIG. 10 is on the basis of the embodiment shown in FIG. 9 and further includes: a sending module 904, configured to send indication information to a server when it is determined that the component to be tested is faulty.

The apparatuses shown in FIG. 9 and FIG. 10 can execute the method for component fault detection based on an image in the foregoing embodiments of the present application. The implementation principles and beneficial effects are the same, and details are not repeated here.

According to an embodiment of the present application, the present application further provides an electronic device and a readable storage medium.

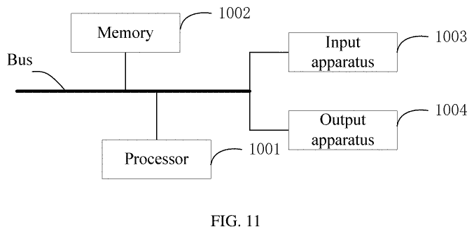

FIG. 11 is a schematic structural diagram of an electronic device for realizing a method for component fault detection based on an image in an embodiment of the present application. An electronic device is intended to represent various forms of digital computers, such as laptop computers, desktop computers, workbenches, personal digital assistants, servers, blade servers, mainframe computers, and other suitable computers. The electronic device may also represent various forms of mobile apparatus, such as personal digital assistants, cellular phones, smart phones, wearable devices, and other similar computing apparatus. The components, their connections and relationships, and their functions shown herein are merely used as examples, and are not intended to be limited to the implementations of the application described and/or required herein.

As shown in FIG. 11, the electronic device includes: one or more processors 1001, a memory 1002, and interfaces for connecting components, including a high-speed interface and a low-speed interface. The components are interconnected using different buses and can be installed on a common motherboard or installed in other ways as required. The processor can process instructions executed within the electronic device, including instructions stored in or on the memory for displaying graphical information of a GUI on an external input/output apparatus (such as a display device coupled to the interface). In other implementations, multiple processors and/or multiple buses can be used with multiple memories, if required. Similarly, multiple electronic devices can be connected, and each providing some necessary operations (for example, as a server array, a set of blade servers, or a multiprocessor system). One processor 1001 is taken as an example in FIG. 11.

The memory 1002 is a non-transitory computer-readable storage medium provided by the present application. The memory stores instructions executable by at least one processor, so that the at least one processor executes the method for component fault detection based on an image provided in the present application. The non-transitory computer-readable storage medium of the present application stores computer instructions, which are used to enable a computer to execute the method for component fault detection based on an image provided by the present application.

As a non-transitory computer-readable storage medium, the memory 1002 may be used to store non-transitory software programs, non-transitory computer-executable programs and modules, such as program instructions/modules corresponding to the method for component fault detection based on an image in the embodiments of the present application (for example, the adjusting module 901, the shooting module 902, and the detection module 903 shown in FIG. 9). The processor 1001 executes various functional applications and data processing of the server by running non-transitory software programs, instructions, and modules stored in the memory 1002, that is, to implement the method for component fault detection based on an image in the above method embodiments.

The memory 1002 may include a program storage area and a data storage area, where the program storage area may store an operating system and an application program required for at least one function; the data storage area may store the data created according to the use of an electronic device for component fault detection based on an image, etc. In addition, the memory 1002 may include a high-speed random access memory, and may also include a non-transitory memory, such as at least one magnetic disk storage device, a flash memory device, or other non-transitory solid-state storage device. In some embodiments, the memory 1002 may optionally include memories that are remotely disposed relative to the processor 1001, which may be connected to the electronic device for component fault detection based on an image through a network. Examples of the above network include, but are not limited to, the Internet, an intranet, a local area network, a mobile communication network and combinations thereof.

The electronic device of the method for component fault detection based on an image may further include: an input apparatus 1003 and an output apparatus 1004. The processor 1001, the memory 1002, the input apparatus 1003 and the output apparatus 1004 may be connected through buses or other manners. The connection through the bus is taken as an example in FIG. 11.

The input apparatus 1003 may receive inputted numeric or character information, and generate key signal input related to user settings and function control of an electronic device for component fault detection based on an image, such as a touch screen, a keypad, a mouse, a trackpad, a touch pad, a pointing stick, one or more mouse buttons, a trackball, a joystick and other input apparatus. The output apparatus 1004 may include a display device, an auxiliary lighting apparatus (for example, an LED), a tactile feedback apparatus (for example, a vibration motor), and the like. The display device may include, but is not limited to, a liquid crystal display (LCD), a light emitting diode (LED) display, and a plasma display. In some implementations, the display device may be a touch screen.

Various implementations of the systems and technologies described here may be implemented in digital electronic circuitry systems, integrated circuit systems, specific ASICs (application specific integrated circuits), computer hardware, firmware, software, and/or combinations thereof. These various implementations may include: being implemented in one or more computer programs that are executable and/or interpreted on a programmable system including at least one programmable processor, where the programmable processor may be a dedicated or general-purpose programmable processor that may receive data and instructions from a storage system, at least one input apparatus and at least one output apparatus, and transmit data and instructions to the storage system, the at least one input apparatus and the at least one output apparatus.

These computing programs (also known as programs, software, software applications, or code) include machine instructions of a programmable processor, and can utilize advanced processes and/or object-oriented programming languages, and/or assembly/machine languages to implement. As used herein, the terms “machine-readable medium” and “computer-readable medium” refer to any computer program product, device, and/or apparatus (for example, a magnetic disk, an optical disk, a memory, a programmable logic device (PLD)) used to provide machine instructions and/or data to the programmable processor, including machine-readable media that receive machine instructions as machine-readable signals. The term “machine-readable signal” refers to any signal used to provide machine instructions and/or data to the programmable processor.

In order to provide interaction with the user, the systems and technologies described here can be implemented on a computer that has: a display apparatus (for example, a CRT (cathode ray tube) or an LCD (liquid crystal display) monitor) for displaying information to the user; and a keyboard and pointing apparatus (for example, a mouse or a trackball) through which the user can provide input to the computer. Other kinds of apparatuses may also be used to provide interaction with the user, for example, the feedback provided to the user may be any form of sensory feedback (for example, visual feedback, auditory feedback, or tactile feedback); and may receive input from the user in any form (including acoustic input, voice input, or tactile input).

The systems and technologies described here can be implemented in a computing system that includes background components (for example, as a data server), or a computing system that includes middleware components (for example, an application server), or a computing system that includes front-end components (for example, a user computer with a graphical user interface or a web browser, through which the user can interact with the implementations of the systems and technologies described here), or a computing system that includes any combination of such background components, middleware components or front-end components. The components of a system may be interconnected by any form or medium of digital data communication (for example, a communication network). Examples of the communication network include: a local area network (LAN), a wide area network (WAN), and the Internet.

A computer system can include a client and a server. The client and the server are generally remote from each other and usually interact through a communication network. A client-server relationship is generated by computer programs running on corresponding computers and having the client-server relationship with each other.

It should be understood that the various forms of processes shown above can be used, and steps can be reordered, added, or deleted. For example, the steps described in this application can be executed in parallel, or sequentially, or in different orders, as long as the desired results of the technical solutions disclosed in the application can be realized, there is no limitation herein.

The above specific implementations do not constitute a limitation to the protection scope of the present application. It should be understood by those skilled in the art that various modifications, combinations, sub-combinations, and substitutions may be made according to design requirements and other factors. Any modification, equivalent replacement and improvement made within the spirit and principle of the application shall be included in the protection scope of the application.

What is claimed is:

1. A method for component fault detection based on an image, comprising:
when it is determined that an image shot by an image pickup apparatus for a component to be tested with a first shooting parameter does not meet a preset condition, adjusting the first shooting parameter to a second shooting parameter, wherein the first shooting parameter and the second shooting parameter both comprise multiple shooting angles;
controlling the image pickup apparatus to shoot for the component to be tested with the second shooting parameter to obtain a first image that meets the preset condition, wherein the first image comprises multiple images shot at multiple shooting angles; and
performing fault detection on the component to be tested according to the first image.

2. The method according to claim 1, wherein each of the first shooting parameter and the second shooting parameter further comprises at least one of the following parameters: a distance between the image pickup apparatus and the component to be tested, a brightness of the image pickup apparatus, a color of the image pickup apparatus, and a focal length of the image pickup apparatus, wherein the first shooting parameter and the second shooting parameter is different in at least one of the parameters.

3. The method according to claim 2, wherein the preset condition comprises one or more of the following: that a coverage area of the component to be tested in the image meets a preset size, that a surface position presented by the component to be tested in the image meets a preset surface position, that the image meets a preset brightness, that the image meets a preset color value, and that the image meets a preset sharpness.

4. The method according to claim 3, wherein the multiple shooting angles are used to shoot for the component to be tested from six sides: top, bottom, left, right, front and back sides, and the shooting is performed from three directions for each side.

5. The method according to claim 1, wherein the performing fault detection on the component to be tested according to the first image comprises:
inputting the first image into a machine learning model to obtain a fault detection result of the component to be tested; wherein the machine learning model is obtained by images of multiple historical components, and an image of each historical component comprises multiple images shot at different shooting angles.

6. The method according to claim 5, further comprising:
controlling the image pickup apparatus to shoot for the multiple historical components to obtain images of the multiple historical components that meet the preset condition; and
training the images of the multiple historical components through a machine learning algorithm to obtain the machine learning model; wherein the machine learning model comprises an image feature of a faulty component in the multiple historical components, and an image feature of a normal component in the multiple historical components.

7. The method according to claim 6, wherein the fault detection result of the component to be tested comprises: that the component to be tested is normal, that the component to be tested has a fault with which the machine learning model has been trained, and that the component to be tested has a fault with which the machine learning model is not trained.

8. The method according to claim 7, wherein when the detection result of the component to be tested is that the component to be tested has a fault with which the machine learning model is not trained, the first image is inputted into the machine learning model for training, to update the machine learning model.

9. The method according to claim 1, wherein after performing fault detection on the component to be tested according to the first image, the method further comprises:
sending indication information to a server when it is determined that the component to be tested is faulty.

10. An apparatus for component fault detection based on an image, comprising:
at least one processor; and a memory communicatively connected to the at least one processor;
wherein the memory stores instructions that are executable by the at least one processor, and when the at least one processor executes the instructions, the at least one processor is configured to: when it is determined that an image shot by an image pickup apparatus for a component to be tested with a first shooting parameter does not meet a preset condition, adjust the first shooting parameter to a second shooting parameter, wherein the first shooting parameter and the second shooting parameter both comprise multiple shooting angles;
control the image pickup apparatus to shoot for the component to be tested with the second shooting parameter to obtain a first image that meets the preset condition, wherein the first image comprises multiple images shot at multiple shooting angles; and
perform fault detection on the component to be tested according to the first image.

11. The apparatus according to claim 10, wherein the shooting parameter further comprises at least one of the following parameters: a distance between the image pickup apparatus and the component to be tested, a brightness of the image pickup apparatus, a color of the image pickup apparatus, and a focal length of the image pickup apparatus, wherein the first shooting parameter and the second shooting parameter is different in at least one of the parameters.

12. The apparatus according to claim 11, wherein the preset condition comprises one or more of the following: that a coverage area of the component to be tested in the image meets a preset size, that a surface position presented by the component to be tested in the image meets a preset surface position, that the image meets a preset brightness, that the image meets a preset color value, and that the image meets a preset sharpness.

13. The apparatus according to claim 12, wherein the multiple shooting angles are used to shoot for the component to be tested from six sides: top, bottom, left, right, front and back sides, and the shooting is performed from three directions for each side.

14. The apparatus according to claim 10, wherein the at least one processor is specifically configured to input the first image into a machine learning model to obtain a fault detection result of the component to be tested; wherein the machine learning model is obtained by images of multiple historical components, and an image of each historical component comprises multiple images shot at different shooting angles.

15. The apparatus according to claim 14, wherein,
the at least one processor is further configured to: control the image pickup apparatus to shoot for the multiple historical components to obtain images of the multiple historical components that meet the preset condition; and
train the images of the multiple historical components through a machine learning algorithm to obtain the machine learning model; wherein the machine learning model comprises an image feature of a faulty component in the multiple historical components, and an image feature of a normal component in the multiple historical components.

16. The apparatus according to claim 15, wherein the fault detection result of the component to be tested comprises: that the component to be tested is normal, that the component to be tested has a fault with which the machine learning model has been trained, and that the component to be tested has a fault with which the machine learning model is not trained.

17. The apparatus according to claim 16, wherein the at least one processor is further configured to: when the detection result of the component to be tested is that the component to be tested has a fault with which the machine learning model is not trained, input the first image into the machine learning model for training, to update the machine learning model.

18. The apparatus according to claim 17, wherein the at least one processor is further configured to send indication information to a server when it is determined that the component to be tested is faulty.

19. A non-transitory computer-readable storage medium, having computer instructions stored thereon, wherein the computer instructions are used to enable a computer to execute the method according to claim 1.
